(19) United States
(12) Patent Application Publication
(10) Pub. No.: US 2006/0269139 A1
(43) Pub. Date: Nov. 30, 2006

(54) Method and program for finding discountinuities

(75) Inventors: Naamen Keskes, Pau (FR); Sebastien Guillon, Pau (FR); Yannick Berthoumieu, Talence (FR); Marc Donias, Bordeaux (FR)

Correspondence Address: STATTLER, JOHANSEN, AND ADELI LLP, 1875 CENTURY PARK EAST SUITE 1360, LOS ANGELES, CA, 90067, US

(73) Assignee: TOTAL S.A., COURBEVOIE (FR)

(21) Appl. No.: 11/391,778

(22) Filed: Mar. 28, 2006

(30) Foreign Application Priority Data
Mar. 29, 2005 (EP) EP 05 29 0689

(51) Int. Cl. G06K 9/46

(52) U.S. Cl. 382/190

(57) ABSTRACT

The invention provides a method for finding discontinuities in an image. This method makes it possible to detect discontinuities, i.e. faults, by being based on the heterogeneity of the distribution of the gradients of the points of the image being studied. The heterogeneity of the distribution of the gradients is characteristic of the discontinuities in a stratified medium. The method is based on the characteristics of the discontinuities within the set of geological markers in order to obtain a better determination of these discontinuities.

### CLAIM OF BENEFIT TO FOREIGN APPLICATION

This application claims benefit to European Patent Application EP 05 29 0689, filed Mar. 29, 2005, which is incorporated herein by reference.

The present invention relates to the finding of a fracture plane in a three-dimensional set of measurements, referred to below as a three-dimensional block. It concerns the fields of geology and, more particularly, seismology.

Particularly in oil exploration, it is known to determine the position of oil reservoirs from the interpretation of geophysical measurements carried out from the surface of the ground or in drilling wells. These measurements typically involve the transmission of a wave into the subsoil and measurement of the various reflections of the wave from the geological structures being studied—surfaces separating distinct materials, fractures, etc.

The measurements lead to the construction of images of the subsoil representing a stack of sedimentary layers affected by discontinuities. Here, discontinuity refers to any break in horizontal or pseudo-horizontal continuity of these layers. Vertical inter-layer discontinuities, of sedimentary nature, are not taken into consideration in this description.

U.S. Pat. No. 5,563,949 describes an oil exploration method in which the exploration volume is divided into cells; in each cell, a coherency value is calculated by considering the values of correlations between pairs of traces lying in different vertical planes. Short correlation windows are used in this document. A good correlation value is representative of a bedded cell. A poor correlation value is representative of sedimentary or structural discontinuities, without it being possible to distinguish between sedimentary or structural discontinuities.

U.S. Pat. No. 5,831,935 and U.S. Pat. No. 5,986,974 relate to the detection of faults by using a difference attribute. This detection does not take into account the distinctions between the various geological markers, such as sedimentary channels, strata, faults as well as noise.

The solutions for the determination of discontinuities in the prior art carry out only a local search for these discontinuities, which entails the mixing of multiple information of structural type, such as faults, sedimentary type such as sedimentary channels, or simply information due to noise. In particular, they do not take into account the specificities of the discontinuities being looked for, i.e. faults. They do not therefore employ a global approach for the faults in the subsoil being studied.

For the determination of discontinuities, it is necessary to eliminate the sedimentary information and the noise and keep only the structural information relating to the discontinuities.

In what follows, the term gradient at a point of an image will refer to a vector quantity representative of the variation in the intensity or amplitude around this point of the image. A component of the gradient vector can be calculated in each direction by considering the ratio of the intensity difference between two neighbouring pixels and the separation of the two pixels along this direction; it is also possible to consider more than two pixels. In a seismic application, the intensity of a pixel in the image is directly proportional to the amplitude of the seismic signal.

The invention consequently provides a method for finding discontinuities in an image, comprising the steps of:
calculating the gradient at a plurality of points of the image;
around a principal point, characterizing at least two windows of points whose gradients have been calculated;
evaluating the heterogeneity of the distribution of the gradients in the windows;
selecting the window that maximizes the heterogeneity and measuring the orientation of this window; and
determining the discontinuities as a function of the heterogeneity value and the orientation of the selected window.

In one embodiment the method comprises, before the step of calculating the gradient, a smoothing step for at least one point with its neighbouring points.

Advantageously, the characterization step comprises a step of partitioning all the windows into aligned sub-windows and the evaluation step comprises multiplication of the heterogeneities of the distributions of the gradients in the sub-windows.

After the selection step, it is furthermore possible to provide a step of weighting the heterogeneity values of the distribution of the gradients in the selected window as a function of the random character of the distribution of these heterogeneity values.

The windows preferably are elongated.
The following may furthermore be provided:
the step of characterizing windows of points whose gradients have been calculated is carried out around a plurality of principal points;
the selection step is carried out for the window that maximizes the heterogeneity around each principal point, and the measurement step is carried out for the orientations of the selected windows;
the step of determining the discontinuities is carried out by comparing the selected windows.

In this case, the method may comprise the following steps between the selection and measurement step and the step of determining the discontinuities:
for a principal point, defining a frame oriented according to the orientation of the window that maximizes the heterogeneity of this principal point and comprises this principal point and one or more principal points; and
calculating the average heterogeneity value of the windows that maximize the heterogeneity of the principal points of the frame, and assigning this value as a heterogeneity value to the principal point for which the frame is defined.

It is possible for the calculation of the average heterogeneity value of the windows that maximize the heterogeneity of the principal points of the frame to be carried out with the heterogeneity values of the principal points of the frame weighted as a function of the angular offset of the frames that maximize the heterogeneity of these points from the orientation of the frame.

Again, the frame is preferably elongated.

The invention also relates to a method for finding a discontinuity in a three-dimensional set of measurements; a three-dimensional discontinuity is reconstructed from discontinuities determined by applying the method mentioned above to sections of the three-dimensional set.

The invention also provides a computer program resident on a computer-readable medium, comprising computer program code means adapted to perform all of the steps of one or other of these methods on a computer. Lastly, the invention relates to a system comprising a memory containing such a program, a logic unit for processing the program and a display unit.

Other characteristics and advantages of the invention will become apparent on reading the following detailed description of the embodiments of the invention, which are given purely by way of example and with reference to the drawings in which:

FIG. 1 shows a schematic representation of a window of points in the absence of a discontinuity;

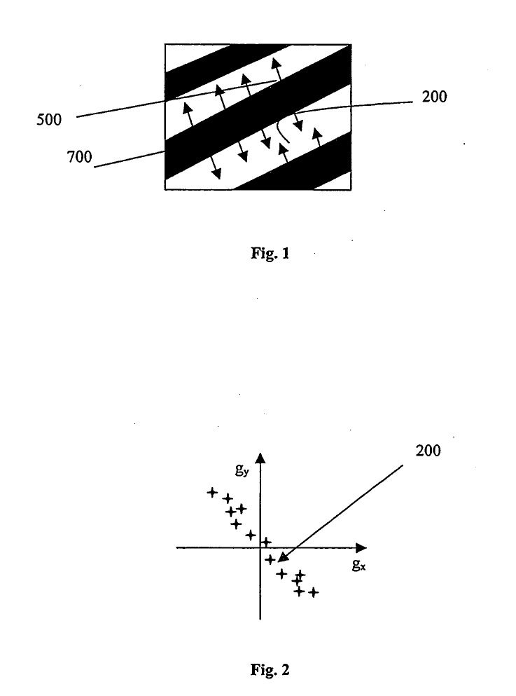

FIG. 2 shows a schematic representation of the distribution of the gradients of a window of points in the absence of a discontinuity;

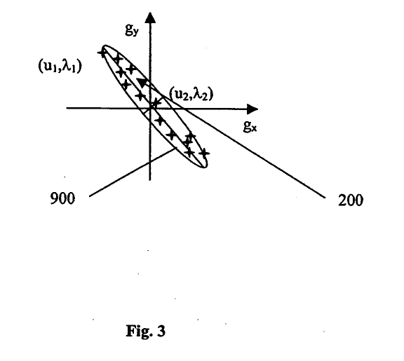

FIG. 3 shows a schematic representation of the elliptical approximation of the distribution of the gradients of a window of points in the absence of a discontinuity;

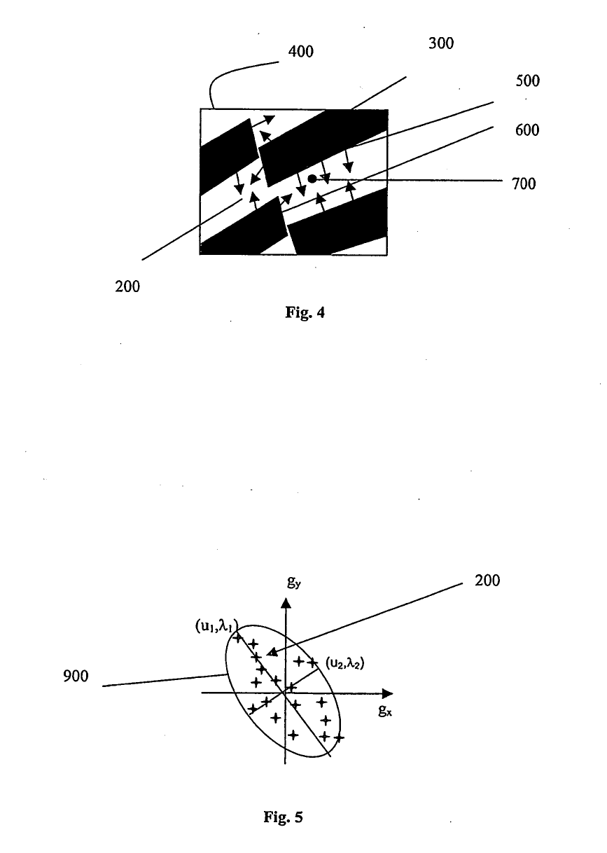

FIG. 4 shows a schematic representation of a window of points in the presence of a discontinuity;

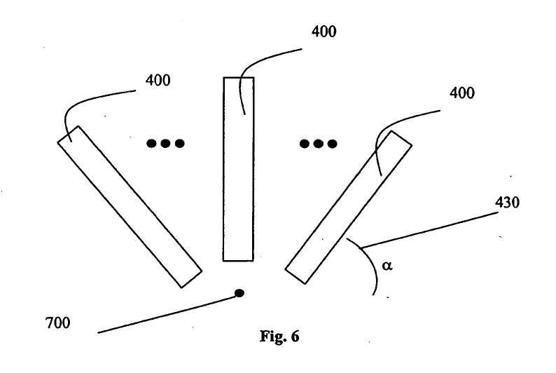

FIG. 5 shows a schematic representation of the elliptical approximation of the distribution of the gradients of a window of points in the presence of a discontinuity;

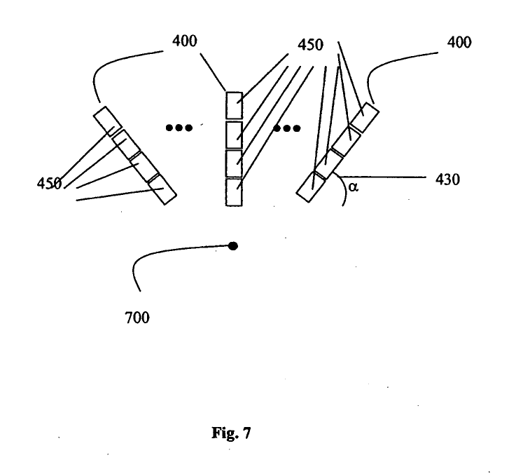

FIG. 6 shows a schematic representation of windows of points around a principal point;

FIG. 7 shows a schematic representation of windows of points partitioned around a principal point;

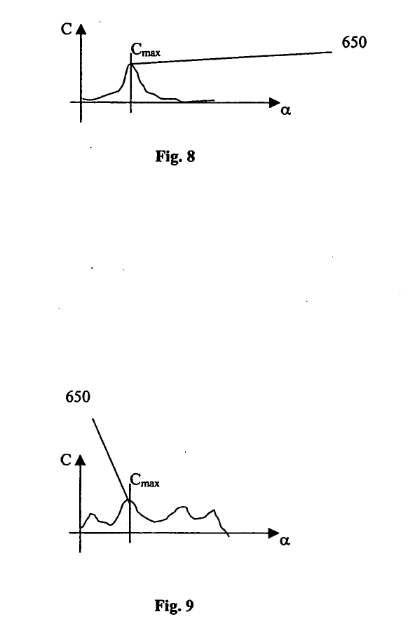

FIG. 8 shows a schematic representation of a heterogeneity distribution around a principal point in the presence of a fault;

FIG. 9 shows a schematic representation of a heterogeneity distribution around a principal point in the presence of noise;

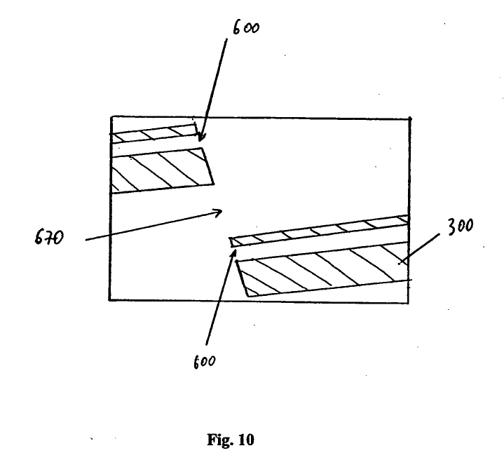

FIG. 10 shows a schematic representation of a window of points in the presence of a discontinuity, a part of which does not intersect any geological horizon;

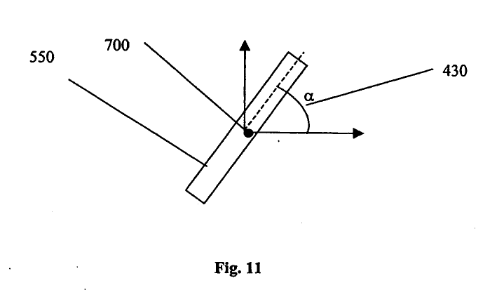

FIG. 11 shows a schematic representation of a window for directional filtering around a point;

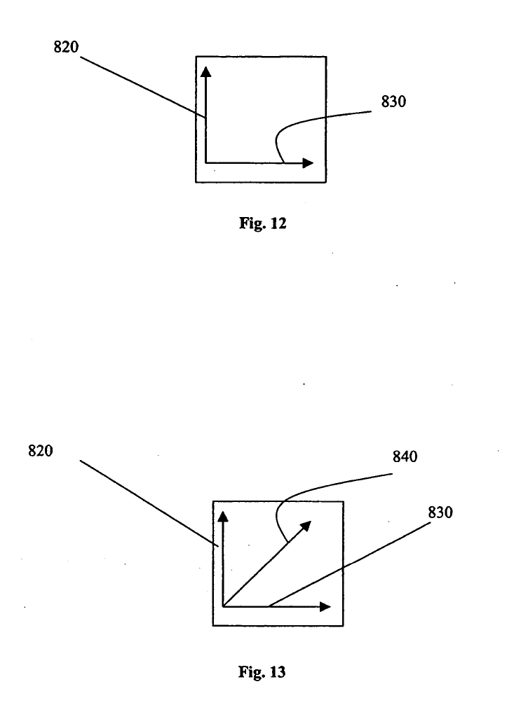

FIG. 12 shows a schematic representation of two processing directions for sections of a three-dimensional set;

FIG. 13 shows a schematic representation of three processing directions for sections of a three-dimensional set.

The invention provides a method for finding discontinuities in an image. This method makes it possible to detect discontinuities, i.e. faults, by being based on the heterogeneity of the distribution of the gradients of the points of the image being studied. The heterogeneity of the distribution of the gradients is characteristic of the discontinuities in a stratified medium.

The image may be a section of a three-dimensional set of measurements, such as the subsoil, which comprises numerous different geological structures such as sediment channels, faults, any other geological horizon or marker, as well as noise. The search for a discontinuity in this image corresponds to the search for a discontinuity of one of these geological or seismic horizons. The image is advantageously stratified.

FIG. 1 is a schematic representation of a window 400 of points in the absence of a discontinuity. FIG. 1 shows gradients of the amplitude of the seismic signal 200 on seismic horizons 300 of a window 400 of points, i.e. a portion of an image 100. Each of these gradients 200 represents the value of the gradient 200 at a point 500 of the image, i.e. the variations in amplitude or intensity of the signal of the image 100 at this point 500.

FIG. 4 is a schematic representation of a window 400 of points in the presence of a discontinuity 600 of the seismic horizons 300.

FIG. 6 is a schematic representation of windows 400 of points around a principal point 700 of the image. FIG. 6 shows the windows of orientation angle α₀, αₙ and αₚ 430 whose elongated shape is intended to maximize the presence of discontinuity points 600 in the event of a fault. These windows comprise a set of points of the image, and optionally the principal point 700 around which they are arranged.

The method for finding discontinuities 600 in an image 100 comprises first the step of calculating the gradient 200 at all points 500 of the image. A step of characterizing windows 400 of points 500, whose gradient has been calculated, is subsequently carried out around a principal point 700 of the image, this step subsequently making it possible to restrict the search for a discontinuity 600 to grouped sets of varied shapes, i.e. these windows, of points whose gradient has been calculated. A step of evaluating the heterogeneity of the distribution of the gradients 200 in the window or windows 400 is also performed, which makes it possible to measure this criterion characteristic of the presence of discontinuities. A selection of the window 400 that maximizes the heterogeneity is furthermore carried out, as well as a measurement of the orientation of this window so as to determine the window 400, i.e. the grouped set of points whose gradient has been calculated, for which the criterion for the presence of a discontinuity 600 is maximally fulfilled, that is to say for which the heterogeneity of the distribution of the gradients is greatest. Lastly, a determination of the discontinuities 600 is performed with the heterogeneity and orientation values of the selected window 400. The selected window may simply be considered around the principal point in question. It is also possible to determine that a discontinuity is present only when the value of the heterogeneity in the windows selected for the various points is greater than a minimum value of the heterogeneity.

A geological discontinuity 600, such as a fault, is locally considered as noise which will perturb the continuity of the other seismic horizons 300, such as a sedimentary stratum. Thus, in order to detect the presence or absence of a discontinuity 600, the method uses measurement of the heterogeneity C of the continuity of the seismic horizons 300. If the heterogeneity C is strong, the probability of the presence of anomalies, i.e. a discontinuity 600, is high.

This method of measuring heterogeneity and finding the maximum heterogeneity in the windows 400 which are defined by the angles 430 makes it possible to improve the prior art by offering better visibility of the discontinuities 600 that are determined on the images 100 being studied. The pseudo-vertical and elongated shape of the windows 400 advantageously make it possible to eliminate the sedimentary discontinuities or those due to the noise, which by definition have little vertical consistency. This also makes it possible to automatically determine the planes of discontinuities 600 such as faults, insofar as the information available, i.e. the determination of the discontinuities 600 of the image, after application of the method is linked only with the structural information, i.e. the discontinuities 600, and not with the sedimentary information, such as the channels formed by the sediments, or noise. This furthermore makes it possible to improve the analysis of relays or networks of discontinuities 600, i.e. faults. The precision in the study of a reservoir in the subsoil and the analysis of the leaktightness of this reservoir in the subsoil are therefore improved. The discontinuities are furthermore characterized in their totality, or at least piecewise, rather than locally. The discontinuities are determined by their alignment.

The heterogeneity measurement is carried out by a statistical analysis of the gradients 200. The statistical analysis is performed by using the principal component analysis (PCA) method.

The gradients may be calculated by the Deriche method or by a local approximation of this method. The gradient 200 of a point may also be calculated by applying this Deriche method based on the square of the 5 points neighbouring this calculation point. It should be recalled that the gradients 200 are oriented in the direction of greatest intensity variation. In the case of a seismic image 100, these gradients 200 are therefore orthogonal to the seismic horizons 600.

As regards the statistical analysis of the gradients, the principle of the PCA method is as follows. Considering a principal point 700 of coordinates (x, y) in the image; considering a window 400 of points 500 of the image, which therefore comprises a set of n points 500 of the image, this window being arranged around the principal point 700; considering the set {Gᵢ=gₓᵢ, g_{yi}} of the n gradients 200 defined at the n points 500 of the window which is arranged around the principal point 700 of coordinates (x, y), the PCA method will first carry out a decomposition into eigenelements of the covariance matrix A of the set {Gᵢ=gₓᵢ, g_{yi}} of the n gradients 200, each gradient being characterized by its abscissa gₓ and its ordinate g_{y}:

$$A = ( \begin{matrix}{\sum }_{i} {g}_{xi}^{2} & {\sum }_{i} {g}_{xi} \cdot {g}_{yi} \\ {\sum }_{i} {g}_{xi} \cdot {g}_{yi} & {\sum }_{i} {g}_{yi}^{2}\end{matrix} )$$

FIG. 2 is a schematic representation of the gradients 200 of a window 400 of points in the absence of a discontinuity 600. It shows the set {Gᵢ=gₓᵢ, g_{yi}} of the n gradients 200 which are calculated on the basis of a principal point 700 of FIG. 1 and n points of the window 400 of FIG. 1, for which the gradient is calculated. FIG. 3 is a schematic representation of the elliptical approximation of the gradients 200 of a window 400 of points in the absence of a discontinuity, specifically the approximation of this set of n gradients 200 presented in FIG. 2 by an ellipse 900 whose direction and elongation are given respectively by the eigenvectors uᵢ and the eigenvalues λᵢ of the matrix A.

FIG. 4 represents the same elements as those presented in FIG. 1, but relating to a window 400 comprising a discontinuity 600. FIG. 5 is a schematic representation of the elliptical approximation of gradients of a window of points in the presence of a discontinuity. It therefore shows the same elements as those in FIG. 3, but correlated with the data described in FIG. 4. Comparison of FIGS. 1 and 3 with FIGS. 4 and 5 shows that in the presence of a discontinuity 600, as in FIG. 4, the ellipse 900 tends to broaden (FIG. 5); the elongation of the second axis 2 is an indicator of the presence of discontinuities 600; it characterizes the heterogeneity of the gradients.

Concerning the study of the discontinuities 600 around a principal point 700, the method characterizes at least one window 400 of points whose gradient has been calculated, which is arranged around the principal point 700.

The selection of the window 400 that maximizes the heterogeneity, from among a plurality of windows 400 arranged around a principal point 700, makes it possible to obtain the zone of points around this principal point 700, delimited by the maximization window 400, in which the probability of the presence of a discontinuity 600 is greatest.

The discontinuities 600 are determined by the correlation between the selected windows 400, their heterogeneity value, there orientation α 430, i.e. their respective alignments, and their proximity.

Increasing the number of windows 400 around a principal point 700 makes it possible to optimize the selection.

Insofar as the discontinuities 600 are often aligned, the search for a discontinuity 600 is advantageously carried out by using windows 400 whose shapes advantageously adopt those of a discontinuity 600. The size and morphology of the analysis window 400 are thus two elements making it possible to optimize the determination of a discontinuity 600. Since the discontinuities 600 being looked for are often aligned, it is hence advantageous to use windows 400 which are substantially vertical, i.e. linear and elongated. It is advantageous for the width of the window, which is longer than the base, to be finally directed in the direction of the orientation of the maximization window. This makes it possible to have a window with a shape optimally matching a zone having a high probability of containing a discontinuity. The size of the calculation window 400 should be assessed as a function of the studied data of the image 100, or the three-dimensional set, available to the user. In particular, the size of the window 400 advantageously depends on the scale of the variations in the data of the image 100 being studied, such as the geological horizons present in the image.

FIG. 7 is a schematic representation of windows of points partitioned around a principal point. FIG. 7 shows windows of orientation angle α₀, αₙ and αₚ 430. It also shows a partition of windows 400 into sub-windows 450, i.e. portions. In order to ensure a high degree of discontinuity in a window, i.e. a high heterogeneity value, this window may be partitioned into a plurality of sub-windows 450. The calculation of the heterogeneity may be carried out on the basis of multiplying the heterogeneities calculated in the sub-windows 450 of a window 400. This makes it possible to obtain a high heterogeneity value in a window if and only if the discontinuities 600 are present in all the sub-windows 450. This therefore permits advantageous determination of the discontinuities 600 owing to better selection of a maximization window 400 which best characterizes the discontinuity 600.

The elongation of the second axis 2 of the approximation ellipse 900 of a set of gradients 200 is an indicator of the presence of discontinuities 600; it characterizes the heterogeneity of the gradients. Use of this criterion of the elongation of the second axis 2 in order to detect the discontinuities 600, however, is contingent on the local amplitude of the seismic signal. This amplitude may give large variations on the image 100. It is advantageous to normalize the detection of the discontinuities over the entire image. This normalization may be carried out by the AGC (Automatic Gain Control) method applied to the image 100. This method consists in normalizing a point of the image by the local average of the amplitudes, which is estimated over the vicinity of this point.

FIG. 8 is a schematic representation of a heterogeneity distribution around a principal point in the presence of a fault. It shows the distribution of the heterogeneity values C of the windows as a function of the orientation α 430. The orientations α₀, αₙ and αₚ 430 of windows, as represented in FIG. 6, are represented on this diagram in the presence of a fault only in the window of orientation an. The curve of FIG. 8 is characteristic of the presence of a fault. The distribution of the heterogeneity value C is very tight around the position of the maximal heterogeneity Cₙ 650 for the window of orientation αₙ.

FIG. 9 is a schematic representation of a heterogeneity distribution around a principal point in the presence of noise. It shows the distribution of the heterogeneity values C of the windows as a function of the orientation α 430. The orientations α₀, an and αₚ 430 of windows, as represented in FIG. 6, are represented on this diagram in a noisy zone and therefore in the case in which the causes of the heterogeneity are disparate. The distribution of the heterogeneity value C is more random therein. As represented in the figure, strong heterogeneities can thus be observed in certain windows such as those of orientation αₙ and αₚ, whereas only a weaker heterogeneity of the gradients will be present in other windows such as that of orientation α₀, even though no discontinuity is present around the principal point being studied. In fact, in the presence of a discontinuity 600 such as a fault around a principal point 700, this generally linear discontinuity 600 is most often present in only one direction. There are nevertheless exceptions to this principle, particularly in the case of an intersection of faults.

It is therefore advantageous to improve the assessment of the heterogeneity by weighting the heterogeneity value C of the various windows 400 around the principal point 700 as a function of the random character of the distribution of the heterogeneity values C. Considering the distribution of the heterogeneity values C(α) as a function of the orientation angle α 430, such weighting may be carried out by measuring the average \overline{α} of the orientations α 430 as well as the variance σ_{α}. If αₘₐₓ denotes the orientation α 430 of the maximization window 400 where the heterogeneity is maximal, then the maximal heterogeneity value Cₘₐₓ is weighted by the function:

$${C}_{max} = {C}_{max} \cdot exp ( \frac{( {α}_{max} - \overline{α} ) \cdot ( {α}_{max} - \overline{α} )}{2 \cdot {k}^{2}} ) / {σ}_{α} \qquad ( 30 )$$

with k a weighting coefficient (when k is smaller, distributions with a single tight peak and therefore the presences of a fault are favoured more).

In the case of a noisy zone, this weighting function 30 causes a decrease of the heterogeneity value C of the maximization window 400. This is because the average \overline{α} of the orientations is far from αₘₐₓ in a noisy zone, i.e. the a value 430 where the heterogeneity is maximal and the variance σ_{α} is large. Application of the previous weighting formula 30 to the heterogeneity value of the maximization window around the principal point 700 being studied therefore decreases the heterogeneity value.

In the presence of a discontinuity 600 as represented in FIG. 8, conversely, the variance σ_{α} is low and the average a of the orientations is close to αₘₐₓ. In this case, application of the weighting function 30 leads to an increase in the heterogeneity value of the maximization window.

In what preceded, the application of the method at one principal point of the image was described. The step of characterizing windows 400 of points whose gradient has been calculated may advantageously be carried out around a plurality of principal points 700. This makes it possible to obtain a wealth of information about the possible presence of discontinuities 600 in the image 100. The number of principal points may be chosen as a function of the size of the windows and the orientation of these windows. For vertical or pseudo-vertical windows of L×m pixels, for example, forming an angle α with the vertical which varies from a limiting angle −αₗᵢₘ to a limiting angle +αₗᵢₘ, it is feasible to choose principal points which are distributed
with a vertical distance of the order of L.cos αₗᵢₘ pixels, or 0.8×L.cos αₗᵢₘ
with a horizontal distance of the order of m.sin αₗᵢₘ or 0.8×m.sin αₗᵢₘ.

Other choices ensure that the windows around the principal pixels scan the entire image without leaving holes.

Note that it is also possible to regard every point of the image as being a principal point. The overlap of the windows is then a maximal.

The selection step is carried out for the window 400 that maximizes the heterogeneity around each principal point 700, and the measurement step is carried out for the orientations of the selected windows, which allows a window that optimizes the criterion for the presence of a discontinuity, arranged around each principal point, to be obtained for each principal study point 700. The determination step is performed by comparing the selected windows. The determination of the discontinuities is carried out in particular by comparing the heterogeneity values, the orientations and/or the proximity of the windows. Correlation of these various factors makes it possible to determine a discontinuity, or even separate discontinuities. For example, the adjacent windows of adjacent principal points having
an orientation which is equal or differs by less than 10°;
a heterogeneity factor which is identical or with a difference of less than 20% may be retained.

Using a plurality of principal points makes it possible to construct or determine faults with a dimension greater than the dimension of the window being considered, by assembling the windows around the principal points. The amount of calculation is limited by limiting the size of the windows, but without this limitation of the size of the windows imposing a limitation on the size of the faults being determined.

FIG. 10 is a schematic representation of a window 400 of points in the presence of a discontinuity 600, a part of which does not intersect any geological horizon. The discontinuity 600 may in fact not be continuous on the image 100 as analyzed, particularly because of difficulties in reconstruction of the signal, the presence of sedimentary information or other geological horizons that may be intersected by the discontinuity 600. The discontinuity thus cannot be determined easily. It is therefore advantageous to reinforce the continuity of the discontinuity 600, that is to say to characterize the presence of the discontinuity in a zone 670 in which any characterization of the discontinuity 600 seems absent. Directional filtering is thus carried out at least at one principal point 700, in the direction of the orientation α 430 of its maximization window 400. As shown by FIG. 11, which is a schematic representation of directional filtering around a principal point, this filtering may be carried out by defining a frame 550 of points oriented along the direction α 430 of the window 400 that maximizes the heterogeneity of this principal point. This frame may comprise this principal point 700 as well as other principal points 700, so that a comparison can be made between the heterogeneities of these various points. The frame 550 may furthermore be symmetrical with respect to the principal point 700, which will allow filtering on the basis of a homogeneous zone of points around the principal point. Various filtering methods may be applied. For instance, one possibility is to assign the average heterogeneity of the maximization windows of the principal points of the frame to the maximization window of the principal point around which the frame is defined. It is also possible to employ the principle that if the points inside the frame 550 belong to the same discontinuity 600, then the values of the orientations α 430 of the maximization windows 400 of these points are substantially the same. Therefore, the more the maximization windows of the points of the frame have an orientation differing from the orientation α 430 of the maximization window of the principal point 700 around which the frame is defined, the greater is the probability that these points do not belong to a discontinuity or to the same discontinuity. The maximization window of the principal point 700 around which are the frame is defined is thus assigned a heterogeneity value taking into account the heterogeneity value of the various points of the frame 550, weighted by the offset of these points from the orientation α 430 of the maximization window of the principal point, around which the frame is defined. The weighting may be carried out according to the function 40:

$$F ( x , y ) = {\sum }_{( i , j ) {F}_{α}} C ( i , j ) \cdot exp ( - \frac{{( α ( x , y ) - α ( i , j ) )}^{2}}{2 \cdot {k}^{2}} ) \qquad ( 40 )$$

where F(x, y) is the heterogeneity value at a principal point 700 of coordinates (x, y) after the directional filtering.

Since a discontinuity 600 is often linear, the frame 550 will advantageously be elongated in order to best match the shapes of a possible discontinuity 600, as explained for the preferred form of a window 400. This frame advantageously extends along one direction. Its base may be narrower than its height directed along the orientation of the maximization window of the principal point around which the frame is defined.

The determination of the discontinuity 600 is carried out image 100 by image 100, i.e. bidimensionally.

A discontinuity 600 coming from a three-dimensional set can be determined then reconstructed. This may be done by applying the method to sections of the three-dimensional set, such as sections of the subsoil. The possible discontinuities may be determined by applying the method to sections of the three-dimensional set which are orthogonal to the two axes of the coordinates 820 and 830 of the three-dimensional set, as shown by FIG. 12 which is a schematic representation of the two processing directions for sections of a three-dimensional set. It may be advantageous to perform such an operation by adding other processing directions orthogonal to the sections, such as the 45° direction 840 in FIG. 13, which is a schematic representation of three processing directions for sections of a three-dimensional set. A given discontinuity 600 present in different sections is determined by carrying out a correlation of the parameters of this discontinuity 600 between the various sections. Approximation and interpolation methods may particular be used in order to perform the reconstruction.

In the application to processing seismic data, the invention uses the fact that the discontinuities have different shapes according to their nature. Structural discontinuities or faults are elongated and aligned; they are also vertical or pseudo-vertical. Conversely, sedimentary discontinuities are shorter. The use of an elongated window makes it possible to effectively detect elongated faults. The pseudo-verticality of faults—the fact that the general direction of the faults may be inclined with respect to the vertical—is taken into account by the angle that the windows may make with the vertical and by the choice of a plurality of windows. On the other hand, the sedimentary discontinuities which are shorter than faults are not significantly represented in the windows.

The dimension of the windows may advantageously be adjusted as a function of the nature of the faults to be detected. A window with a dimension of 50×1 pixel may typically be used, that is to say an elongation (length to width ratio) of 50. More generally, an elongation of 20 or more makes it possible to detect the structural discontinuities while eliminating the majority of the sedimentary discontinuities.

The number of windows used depends on the inclination of the faults to be detected: when inclined faults are intended to be detected, the number of windows will be commensurately greater.

The angle between two neighbouring windows depends on the length of the windows and is chosen in order to ensure that a fault of the intended type is covered well by a window. For an elongation of 50, for example, an angle between two windows with a tangent of 1/25 may be used, that is to say an angle of the order of 7.2°. Such a choice ensures that the short sides of two neighbouring windows are substantially adjacent; in this way, the windows in question completely cover the angular sector being scanned.

In one example, the following values are used
calculation of the gradient at all points of the image;
choice of principal points spaced vertically by 1 pixel and spaced horizontally by 1 pixel, that is to say all the points of the image are principal;
window with a dimension of 70 by 1 pixel;
limiting inclination of the various windows: 40°;
angle between two neighbouring windows: 2°.

These numerical values make it possible to determine the faults in a calculation time of 10 seconds, for an image with a dimension of 1000×1000 pixels. The calculation is carried out on an HP brand workstation model XW8000 having 2 Go of RAM.

The present invention also relates to a program implementing the method described above. The program may comprise a routine of receiving an image 100; a routine of calculating the gradient 200 at a plurality of points 500 of the image 100; a routine of characterizing windows 400 of points 500, whose gradient 200 has been calculated, around a point 700; a routine of evaluating the heterogeneity of the distribution of the gradients 200 in the window or windows 400; a routine of selecting the window 400 that maximizes the heterogeneity and a routine of measuring the orientation of this window 400; and a routine of determining the discontinuities 600 on the basis of the heterogeneity and orientation values of the selected window 400. The program resides on a computer-readable medium and thus comprises computer program code means adapted to carry out the steps of the aforementioned method on a computer.

In particular, this program makes it possible to improve the prior art by offering better visibility of the discontinuities 600 determined on the images 100 being studied. This program also makes it possible to automatically determine the planes of discontinuities 600, such as faults, insofar as the information available, i.e. the determination of the discontinuities 600 of the image, after application of the method is linked only with the structural information, i.e. the discontinuities 600, and not with the sedimentary information, such as the channels formed by the sediments. This program furthermore makes it possible to improve the analysis of relays or networks of discontinuities 600, i.e. faults. It therefore improves the precision in the study of a reservoir in the subsoil and the analysis of the leaktightness of this reservoir in the subsoil.

The program also presents all of the advantages attributed to the method. Programming of the routines of the program is within the scope of the person skilled in the art, in view of the indications provided above with reference to the figures. In order to make the programming of the invention relatively easy, it is preferable to use a high-level language which allows object-oriented programming, such as C++ or the JAVA language. Mathematical function libraries available commercially may be used, in particular as regards calculation of the gradient or the statistical analyses.

The present invention also relates to a system comprising a memory containing the program described above, a logic unit for processing the program and a display unit. This system presents the same advantages as those attributed to the method and the program.

What is claimed is:

1. Method for finding discontinuities in an image, comprising the steps of:
calculating the gradient at a plurality of points of the image;
around a principal point, characterizing at least two windows of points whose gradients have been calculated;
evaluating the heterogeneity of the distribution of the gradients in the windows;
selecting the window that maximizes the heterogeneity and measuring the orientation of this window; and
determining the discontinuities as a function of the heterogeneity value and the orientation of the selected window.

2. Method according to claim 1, wherein the said method comprises, before the step of calculating the gradient, a smoothing step for at least one point with its neighbouring points.

3. Method according to claim 1, wherein the characterization step comprises a step of partitioning all the windows into aligned sub-windows, and in that the evaluation step comprises multiplication of the heterogeneities of the distributions of the gradients in the sub-windows.

4. Method according to claim 1, wherein the said method furthermore comprises, after the selection step, a step of weighting the heterogeneity values of the distribution of the gradients in the selected window as a function of the random character of the distribution of these heterogeneity values.

5. Method according to claim 1, wherein the windows are elongated.

6. Method according to claim 1, wherein:
the step of characterizing windows of points whose gradients have been calculated is carried out around a plurality of principal points;
the selection step is carried out for the window that maximizes the heterogeneity around each principal point, and the measurement step is carried out for the orientations of the selected windows;
the step of determining the discontinuities is carried out by comparing the selected windows.

7. Method according to claim 6, wherein between the selection and measurement step and the step of determining the discontinuities, the said method furthermore comprises the steps of:
for a principal point, defining a frame oriented according to the orientation of the window that maximizes the heterogeneity of this principal point and comprises this principal point and one or more principal points; and
calculating the average heterogeneity value of the windows that maximizes the heterogeneity of the principal points of the frame, and assigning this value as a heterogeneity value to the principal point for which the frame is defined.

8. Method according to claim 7, wherein the calculation of the average heterogeneity value of the windows that maximizes the heterogeneity of the principal points of the frame is carried out with the heterogeneity values of the principal points of the frame weighted as a function of the angular offset of the frames that maximizes the heterogeneity of these points from the orientation of the frame.

9. Method according to claim 7, wherein the frame is elongated.

10. Method according to claim 1 for finding a discontinuity in a three-dimensional set of measurements, comprising the reconstruction of a three-dimensional discontinuity using discontinuities determined by applying the method to sections of the three-dimensional set.

11. Computer program resident on a computer-readable medium, comprising computer program code means adapted to perform on a computer all of the steps of a method for finding discontinuities in an image, comprising the steps of:
calculating the gradient at a plurality of points of the image;
around a principal point, characterizing at least two windows of points whose gradients have been calculated;
evaluating the heterogeneity of the distribution of the gradients in the windows;
selecting the window that maximizes the heterogeneity and measuring the orientation of this window; and
determining the discontinuities as a function of the heterogeneity value and the orientation of the selected window.

12. System comprising:
a memory containing a program resident on a computer-readable medium, comprising computer program code means adapted to perform on a computer all of the steps of a method for finding discontinuities in an image, comprising the steps of:
calculating the gradient at a plurality of points of the image;
around a principal point, characterizing at least two windows of points whose gradients have been calculated;
evaluating the heterogeneity of the distribution of the gradients in the windows;
selecting the window that maximizes the heterogeneity and measuring the orientation of this window; and
determining the discontinuities as a function of the heterogeneity value and the orientation of the selected window;
a logic unit for processing the program; and
a display unit.

13. Method according to claim 6, wherein the said method comprises, before the step of calculating the gradient, a smoothing step for at least one point with its neighbouring points.

14. Method according to claim 6, wherein the characterization step comprises a step of partitioning all the windows into aligned sub-windows, and in that the evaluation step comprises multiplication of the heterogeneities of the distributions of the gradients in the sub-windows.

15. Method according to claim 6, wherein the said method furthermore comprises, after the selection step, a step of weighting the heterogeneity values of the distribution of the gradients in the selected window as a function of the random character of the distribution of these heterogeneity values.

16. Method according to claim 6, wherein the windows are elongated.

17. Method according to claim 4, wherein the said method comprises, before the step of calculating the gradient, a smoothing step for at least one point with its neighbouring points.

18. Method according to claim 4, wherein the characterization step comprises a step of partitioning all the windows into aligned sub-windows, and in that the evaluation step comprises multiplication of the heterogeneities of the distributions of the gradients in the sub-windows.

19. Method according to claim 4, wherein the windows are elongated.

20. Method according to claim 7, wherein the said method furthermore comprises, after the selection step, a step of weighting the heterogeneity values of the distribution of the gradients in the selected window as a function of the random character of the distribution of these heterogeneity values.
